(19) United States
(12) Patent Application Publication
(10) Pub. No.: US 2015/0064550 A1
(43) Pub. Date: Mar. 5, 2015

(54) PRISMATIC SECONDARY CELL

(71) Applicants: Tatsuhiko Kawasaki, Hitachinaka (JP); Nobuyuki Hori, Hitachinaka-shi (JP)

(72) Inventors: Tatsuhiko Kawasaki, Hitachinaka (JP); Nobuyuki Hori, Hitachinaka-shi (JP)

(73) Assignee: Hitachi Automotive Systems, Ltd.

(21) Appl. No.: 14/376,559

(22) PCT Filed: Feb. 22, 2012
(86) PCT No.: PCT/JP2012/054258

§ 371 Date: Oct. 7, 2014

(51) Int. Cl. H01M 2/36

(52) U.S. Cl. CPC H01M 2/365
USPC 429/185

(57) ABSTRACT

An object of the present invention is to provide a prismatic secondary cell 1 having a structure that makes it easy to inject an electrolytic solution into a cell can 2 and seal the cell can. The prismatic secondary cell 1 is configured so that an electrode group 4 is housed in the cell can 2 and that an opening 2a in the cell can 2 is sealed with a cell lid 3. The prismatic secondary cell 1 includes a solution injection section 7 and a plug section 8. The solution injection section 7 has a plurality of through-holes 21, 22 that penetrate the cell lid 3 and are positioned adjacent to each other. The plug section 8 is attached to the solution injection section 7 to integrally seal the through-holes 21, 22.

### TECHNICAL FIELD

The present invention relates to a prismatic secondary cell that is used, for example, as a vehicle-mounted secondary cell.

### BACKGROUND ART

In recent years, a lithium-ion secondary cell having a high energy density is increasingly developed as a power source for electric vehicles and the like. Although there are variously shaped lithium-ion secondary cells, a prismatic secondary cell is used as a vehicle-mounted cell because it has high volumetric efficiency. For example, a structure disclosed, for instance, in Patent Literature 1 is such that a flatly wound electrode group is housed in a deep drawn cell can with a winding axis placed in a horizontal position. In this structure, the cell can is provided with an opening into which a group of electrical power generating elements is inserted. The opening is sealed with a cell lid. A through-hole is made in the cell lid to inject an electrolytic solution into the cell can. After the opening in the cell can is sealed with the cell lid, the electrolytic solution can be injected with a solution injection nozzle inserted into the through-hole. After the electrolytic solution is injected, the through-hole is sealed with a plug.

### CITATION LIST

### Patent Literature

Patent Literature 1: Japanese Unexamined Patent Application Publication No. 2011-165436

### SUMMARY OF INVENTION

### Technical Problem

According to the structure described in Patent Literature 1, there is only one through-hole. Therefore, when the electrolytic solution is to be injected, an opening for allowing air in the cell canto escape is limited to a gap between a solution injection hole and a solution injection nozzle. It means that the electrolytic solution does not readily enter the cell can. Further, a film of electrolytic solution may be formed over the air escape opening to splash the electrolytic solution. Moreover, if a total of two through-holes are made for solution injection and for air discharge, they need to be sealed with two plugs.

The present invention has been made in view of the above circumstances. An object of the present invention is to provide a prismatic secondary cell having a structure that makes it easy to inject an electrolytic solution into a cell can and seal the cell can.

### Solution to Problem

The configuration defined in the appended claims is adopted to solve the above problem. The present invention includes a plurality of means for solving the above problem. According to an exemplary means included in the present invention, there is provided a prismatic secondary cell in which an electrode group is housed in a cell can and an opening in the cell can is sealed with a cell lid. The prismatic secondary cell includes a solution injection section and a plug section. The solution injection section has a plurality of through-holes that penetrate the cell lid and are positioned adjacent to each other. The plug section integrally seals the through-holes in the solution injection section.

### Advantageous Effects of Invention

The present invention provides a prismatic secondary cell having a structure that makes it easy to inject an electrolytic solution and seal. Problems, configurations, and advantageous effects other than described above will become apparent from the following description of embodiments.

### BRIEF DESCRIPTION OF DRAWINGS

FIG. 1 is a perspective view illustrating a prismatic secondary cell according to a first embodiment of the present invention.

FIG. 2 is an exploded perspective view illustrating the prismatic secondary cell according to the first embodiment.

FIG. 3A is an enlarged plan view illustrating essential parts of the prismatic secondary cell according to the first embodiment.

FIG. 3B is a cross-sectional view taken along line A1-A1 of FIG. 3A.

FIG. 4 is a cross-sectional view illustrating a state where a solution injection section is sealed with a plug.

FIG. 5 is a conceptual diagram illustrating a solution injection process according to the first embodiment.

FIG. 6A is an enlarged plan view illustrating essential parts of the secondary cell according to a second embodiment of the present invention.

FIG. 6B is a cross-sectional view taken along line A2-A2 of FIG. 6A.

FIG. 7 is a cross-sectional view illustrating a state where an injection nozzle is inserted into an injection through-hole in the solution injection section.

FIG. 8A is an enlarged plan view illustrating essential parts of the secondary cell according to a third embodiment of the present invention.

FIG. 8B is a cross-sectional view taken along line A3-A3 of FIG. 8A.

### DESCRIPTION OF EMBODIMENTS

A prismatic secondary cell according to the present embodiment is configured so that an electrode group is housed in a cell can and that an opening in the cell can is sealed with a cell lid. The prismatic secondary cell includes a solution injection section and a plug section. The solution injection section has a plurality of through-holes that penetrate the cell lid and are positioned adjacent to each other. The plug section integrally seals the through-holes in the solution injection section.

### First Embodiment

The configuration of the prismatic secondary cell according to a first embodiment of the present invention will now be described with reference to the accompanying drawings. For the sake of convenience, the following description is given on the assumption that a cell lid 3 side of the prismatic secondary cell 1 is referred to as the upper side, and that a bottom side of a cell can 2 is referred to as the lower side. However, it does not specifically define the attitude of the prismatic secondary cell 1.

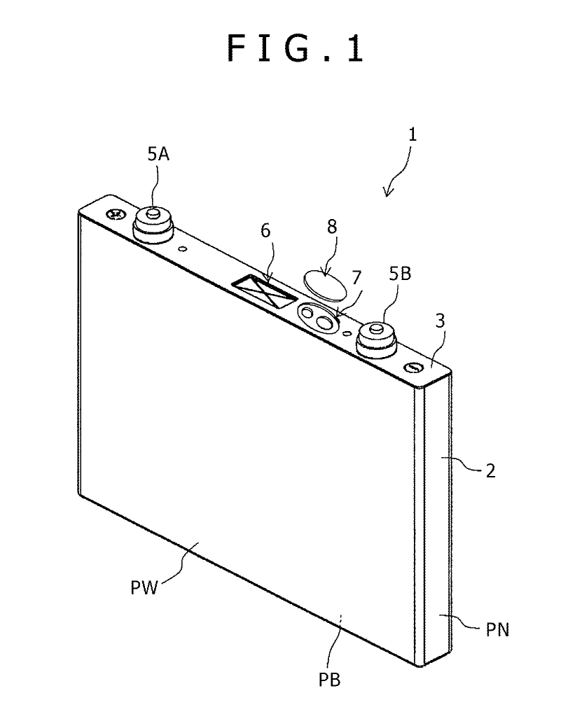

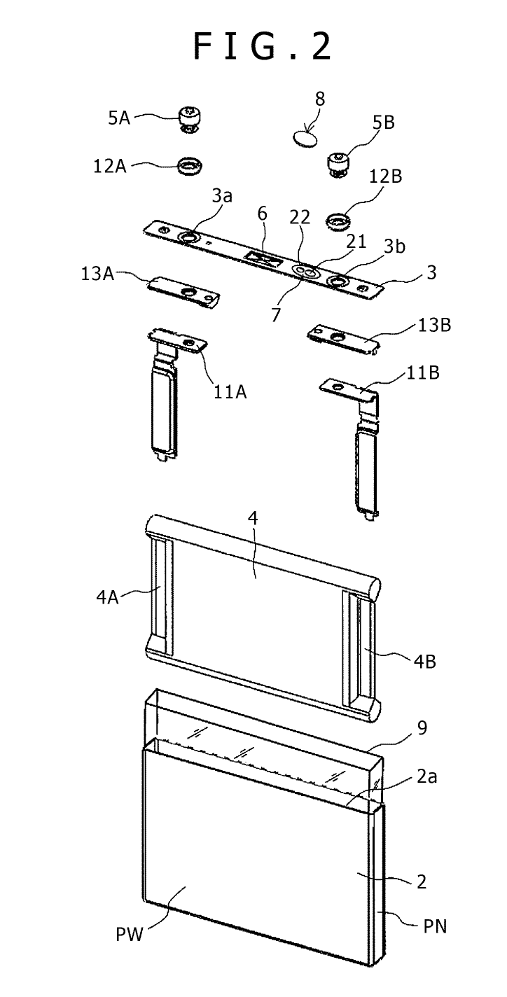

FIG. 1 illustrates the overall configuration of the prismatic secondary cell according to the first embodiment. FIG. 2 is an exploded perspective view illustrating the prismatic secondary cell shown in FIG. 1.

The prismatic secondary cell 1 is a lithium-ion secondary cell that includes the cell can 2 and the cell lid 3 as shown in FIGS. 1 and 2. The cell can 2 is shaped like a rectangular box having an oblong bottom wall surface PB, a pair of wide side wall surfaces PW, and a pair of narrow side wall surfaces PN. The pair of wide side wall surfaces PW are bent at two long sides of the bottom wall surface PB to face each other. The pair of narrow side wall surfaces PN are bent at two end sides of the bottom wall surface PB to face each other. The top of the cell can 2 is provided with a rectangular opening 2a, which is upwardly open.

The cell can 2 houses a later-described electrode group 4. The opening 2a in the cell can 2 is sealed with the cell lid 3. The cell lid 3, which is flat and rectangular in shape, entirely covers the opening 2a in the cell can 2, which is between the upper ends of the pair of wide side wall surfaces PW and the upper ends of the pair of narrow side wall surfaces PN. The cell can 2 and cell lid 3 are formed of an aluminum alloy and laser-welded liquid-tight to form a hermetically-closed container shaped like a rectangular parallelepiped.

A positive terminal 5A and a negative terminal 5B are attached to the cell lid 3 through an insulating member. The positive terminal 5A and the negative terminal 5B are positioned apart from each other and arranged in the direction of the long side of the cell lid 3. More specifically, the positive terminal 5A is disposed toward one side of the cell lid 3 and the negative terminal 5B is disposed toward the other end. Electrical power is supplied from the electrode group 4 to an external load through the positive and negative terminals 5A, 5B. Further, externally generated electrical power is charged into the electrode group 4 through the positive and negative terminals 5A, 5B.

A gas discharge valve 6 and a solution injection section 7 are attached to the cell lid 3 in addition to the positive and negative terminals 5A, 5B. The gas discharge valve 6 is disposed at the longitudinal center of the cell lid 3. The solution injection section 7 is disposed between the gas discharge valve 6 and the negative terminal 5B.

When the pressure in a cell container rises above a predetermined value, the gas discharge valve 6 opens to discharge a gas in the cell container and reduce the pressure in the cell container for the purpose of assuring the safety of the prismatic secondary cell 1.

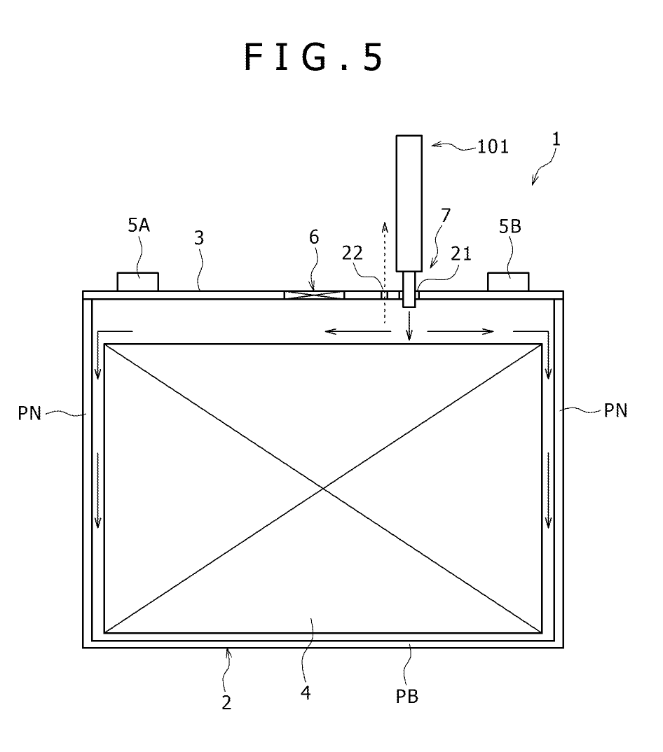

The solution injection section 7 is used to inject an electrolytic solution into the cell can 2 after the opening 2a in the cell can 2 is sealed with the cell lid 3. A solution injection nozzle 101 (see FIG. 5) is used to inject the electrolytic solution. After the electrolytic solution is injected into the cell can 2, the solution injection section 7 is sealed with the plug section 8.

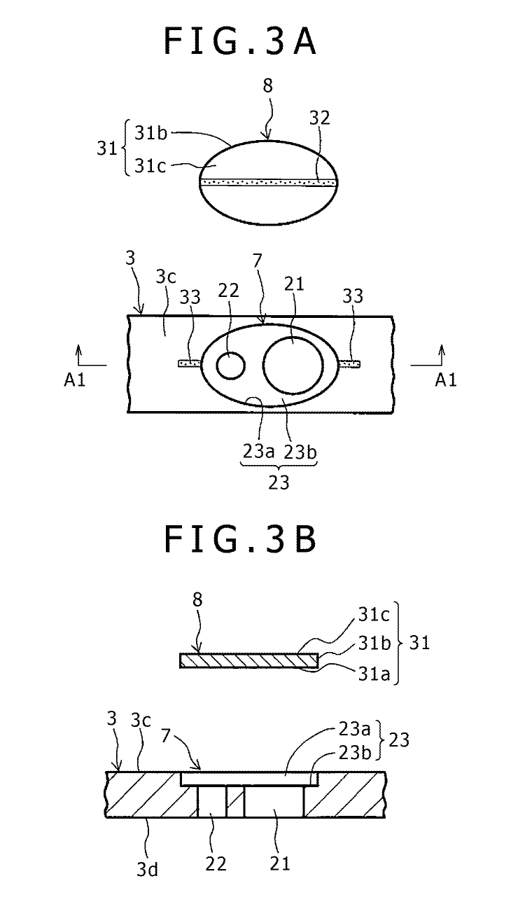

The solution injection section 7 has a plurality of through-holes that penetrate the cell lid 3 and are positioned adjacent to each other. The present embodiment includes a large-diameter through-hole and a small-diameter through-hole as the through-holes. The large-diameter through-hole has a larger diameter than the small-diameter through-hole. The large-diameter through-hole is used as an injection through-hole 21 for injecting the electrolytic solution into the cell can 2. The small-diameter through-hole is used as an air discharge through-hole 22 for discharging air. The injection through-hole 21 and the air discharge through-hole 22 are blocked up by one plug 31 (see FIG. 3) that forms the plug section 8.

The cell can 2 of the prismatic secondary cell 1 houses the electrode group 4 as shown in FIG. 1 with an insulating sheet 9 positioned between the cell can 2 and the electrode group 4. The electrode group 4 is formed by winding positive and negative electrodes with a separator placed in between. The electrode group 4 is flat in shape and has a pair of wide surfaces and a pair of narrow surfaces. A positive electrode connection section 4A including an exposed positive electrode metal foil section is formed at one end in the direction of a winding axis of the electrode group 4. A negative electrode connection section 4B including an exposed negative electrode metal foil section is formed at the other end in the direction of the winding axis of the electrode group 4.

The positive electrode connection section 4A is connected to the positive terminal 5A through a positive electrode current collector plate 11A. The negative electrode connection section 4B is connected to the negative terminal 5B through a negative electrode current collector plate 11B. One end of the positive electrode current collector plate 11A is connected to the positive terminal 5A, and the other end is extended toward the bottom of the cell can 2 from the positive terminal 5A and connected to the positive electrode connection section 4A. One end of the negative electrode current collector plate 11B is connected to the negative terminal 5B, and the other end is extended toward the bottom of the cell can 2 from the negative terminal 5B and connected to the negative electrode connection section 4B.

The positive terminal 5A and the positive electrode current collector plate 11A are formed of an aluminum alloy, and the negative terminal 5B and the negative electrode current collector plate 11B are formed of a copper alloy. The positive terminal 5A and the positive electrode current collector plate 11A and the negative terminal 5B and the negative electrode current collector plate 11B are electrically insulated from the cell lid 3 because insulating seal members (gaskets) 12A, 12B and insulating members 13A, 13B are disposed between the cell lid 3 and the positive terminal 5A and the positive electrode current collector plate 11A and the negative terminal 5B and the negative electrode current collector plate 11B. Through-holes 3a, 3b, which engage with the insulating seal members (gaskets) 12A, 12B, are made in the cell lid 3.

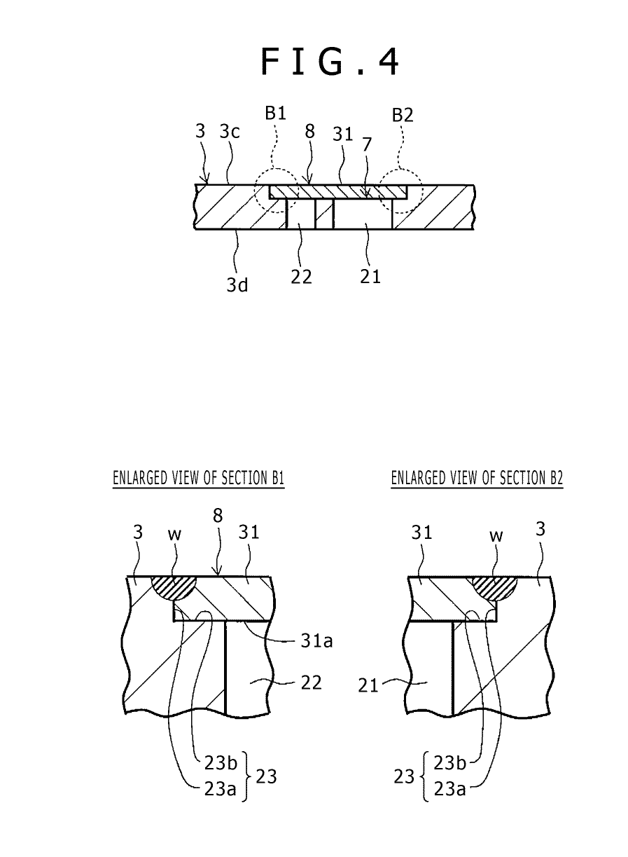

The configurations of the solution injection section 7 and the plug section 8 will now be described in detail with reference to FIGS. 3A, 3B, and 4.

As shown in FIGS. 3A and 3B, the solution injection section 7 has a concave portion 23 that is formed on the front surface 3c of the cell lid 3. As shown in FIG. 3A, the concave portion 23 is elliptically shaped as viewed from above. The longitudinal axis of the ellipse is positioned in the direction of the long side of the cell lid 3. As shown in FIG. 3B, the concave portion 23 has a fixed depth, an elliptical side wall surface 23a, and a planar bottom surface 23b. The upper end of the injection through-hole 21 and the upper end of the air discharge through-hole 22 are open in the bottom surface 23b of the concave portion 23. The lower end of the injection through-hole 21 and the lower end of the air discharge through-hole 22 are open in the back surface 3d of the cell lid 3.

The injection through-hole 21 and the air discharge through-hole 22 are positioned so that the bottom surface 23b of the concave portion 23 exists on the whole circumference of the upper end of the injection through-hole 21 and of the upper end of the air discharge through-hole 22. In other words, the upper end of the injection through-hole 21 and the upper end of the air discharge through-hole 22 are open so that the bottom surface 23b is positioned between such through-holes 21, 22 and the side wall surface 23a of the concave portion 23.

Therefore, when the plug 31 of the later-described plug section 8 is attached to the concave portion 23, the lower surface 31a of the plug 31 comes into contact with the bottom surface 23b of the concave portion 23 to exhibit highly-reliable hermetic sealing performance. The outer surface of the injection through-hole 21 or of the air discharge through-hole 22 may be in internal contact with the side wall surface 23a of the concave portion 23.

The injection through-hole 21 needs to have a larger diameter than the leading end of the solution injection nozzle 101 (see FIG. 5). It is preferred that the gap between the injection through-hole 21 and the solution injection nozzle 101 be small in order, for instance, to prevent the leakage of the electrolytic solution.

The injection through-hole 21 has a larger diameter than the air discharge through-hole 22 in order to smoothly inject a large amount of electrolytic solution within a short period of time. The injection through-hole 21 and the air discharge through-hole 22 are disposed adjacent to each other in the longitudinal axis direction of the ellipse of the concave portion 23. Further, the injection through-hole 21 is disposed near a narrow side wall surface PN of the cell can 2. Therefore, the electrolytic solution injected from the solution injection nozzle 101 can be positively directed toward the bottom of the cell can 2 and stored in the cell can 2.

After the electrolytic solution is injected, the injection through-hole 21 and the air discharge through-hole 22 are integrally sealed by the plug section 8. The plug section 8 is formed of a single plug 31. The plug 31 is formed of a plate-like member that is elliptically shaped as viewed from above and capable of engaging with the concave portion 23. The plug 31 includes a lower surface 31a, an outer surface 31b, and an upper surface 31c. The lower surface 31a comes into contact with the bottom surface 23b of the concave portion 23 to block up both the injection through-hole 21 and the air discharge through-hole 22 when the plug 31 is engaged with the concave portion 23. The outer surface 31b opposes the side wall surface 23a of the concave portion 23. The upper surface 31c is flush with the front surface 3c of the cell lid 3.

The plug 31 is engaged with the concave portion 23 and welded to the cell lid 3 so that a weld zone w is formed along the whole circumference of the outer surface 31b. As shown in FIG. 4, the plug 31 is welded while the lower surface 31a of the plug 31 is in planar contact with the bottom surface 23b of the concave portion 23. Therefore, a large area is in planar contact. Further, the bottom surface 23b of the concave portion 23 exists along the whole circumference of the upper end of the injection through-hole 21 and of the upper end of the air discharge through-hole 22. Therefore, the lower surface 31a of the plug 31 can be brought into planar contact with the whole circumference of the upper end of the injection through-hole 21 and of the upper end of the air discharge through-hole 22. This results in highly-reliable hermetic sealing performance.

An electrolytic solution injection process according to the present embodiment will now be described with reference to FIG. 5.

The electrolytic solution is injected into the cell can 2 by using a solution injection nozzle 101. The cell can 2 to which the cell lid 3 is welded is set in a solution injection device (not shown), and the leading end of the solution injection nozzle 101 is inserted into the injection through-hole 21. In such an instance, the vertical position of the solution injection nozzle 101 is adjusted so that the leading end of the solution injection nozzle 101 does not come into contact with the electrode group 4 in the cell can 2. The solution injection nozzle 101 is coupled, for instance, with a piping to a tank (not shown), which stores the electrolytic solution, and to a syringe (not shown), which controls an electrolytic solution discharge speed and a solution injection amount. The electrolytic solution is discharged from the leading end of the solution injection nozzle 101 and injected into the cell can 2.

The electrolytic solution injected into the cell can 2 from the solution injection nozzle 101 flows along the gap between the electrode group 4 and the cell can 2 and toward the bottom of the cell can 2, and is stored in the cell can 2. The solution injection amount is adjusted to provide a solution level that immerses the electrode group 4.

The gap between the wide side wall surfaces PW of the cell can 2 and the wide surfaces of the electrode group 4 is narrower than the gap between the narrow side wall surfaces PN of the cell can 2 and the narrow surfaces on opposing sides in the direction of the winding axis of the electrode group 4. Hence, most of the electrolytic solution injected into the cell can 2 from the solution injection nozzle 101 flows in two different directions as shown in FIG. 5 when it reaches the upper surface of the electrode group 4, and then flows along the upper surface of the electrode group 4 and toward the narrow side wall surfaces PN on opposing sides in the direction of the width of the cell can 2. Eventually, the electrolytic solution passes through the gap between the narrow side wall surfaces PN of the cell can 2 and the narrow surfaces of the electrode group 4, flows toward the bottom of the cell can 2, and is stored in the cell can 2.

In the present embodiment, the injection through-hole 21 is disposed closer to a narrow side wall surface PN of the cell can 2 than the air discharge through-hole 22. Therefore, the electrolytic solution injected from the solution injection nozzle 101 can be positively directed toward the bottom of the cell can 2 and promptly injected into the cell can 2.

In order to steadily inject the electrolytic solution into the cell can 2 within a short period of time, it is preferred that air replaced by the electrolytic solution in the cell can 2 be efficiently discharged out of the cell can 2. If the air is not adequately discharged, the electrolytic solution is not smoothly injected into the cell can 2. As a result, the electrolytic solution scatters out of the cell can 2. This causes the solution injection amount to vary. Further, if the scattered electrolytic solution remains in the concave portion 23 of the cell lid 3, the remaining electrolytic solution may evaporate when an attempt is made to weld the plug 31 to the cell lid 3. This may result in improper welding.

In the present embodiment, the air discharge through-hole 22 is disposed adjacent to the injection through-hole 21. Hence, the air in the cell can 2 passes through the air discharge through-hole 22 and is forced out of the cell can 2. Consequently, the electrolytic solution can be smoothly injected into the cell can 2. This makes it possible to prevent the electrolytic solution from scattering out of the cell can 2 and stabilize the solution injection amount. Further, the electrolytic solution can be prevented from scattering and attaching to the concave portion 23 of the cell lid 3. This makes it possible to eliminate the cause of improper welding of the plug 31.

The solution injection section 7 is sealed with one plug 31 during a single process. The plug 31 is engaged with the concave portion 23 so that the lower surface 31a of the plug 31 is brought into planar contact with the bottom surface 23b of the concave portion 23. The whole circumference of the outer surface 31b of the plug 31 is then laser-welded to the whole circumference of the side wall surface 23a of the concave portion 23.

According to the prismatic secondary cell 1 having the above-described configuration, the electrolytic solution can be smoothly injected because the solution injection section 7 has the injection through-hole 21 and the air discharge through-hole 22. Further, the plug 31 is engaged with the concave portion 23 of the solution injection section 7 so that both the injection through-hole 21 and the air discharge through-hole 22 are blocked up integrally with the single plug 31. This makes it easy to seal the solution injection section 7.

In the present embodiment, positioning markings 32, 33 for image recognition are put on the upper surface 31c of the plug 31 and the front surface 3c of the cell lid 3, respectively, in order to ensure that the plug 31, which is elliptically shaped as viewed from above, is precisely engaged with the concave portion 23 of the cell lid 3 by using an automatic labor-saving device.

Further, in the present embodiment, the concave portion 23 is elliptically shaped as viewed from above. Alternatively, however, the concave portion 23 may be shaped like an athletic running track, a rectangle, or a polygon. The outer shape of the concave portion 23 is not limited to that described in conjunction with the present embodiment.

Moreover, in the present embodiment, the injection through-hole 21 has a larger diameter than the air discharge through-hole 22. The reason is that the injection through-hole 21 is inevitably larger in diameter than the air discharge through-hole 22 by the wall thickness of the solution injection nozzle 101 as far as the cross-sectional area of the discharge hole in the solution injection nozzle 101 is assumed to be substantially the same as the area of the opening in the air discharge through-hole 22. Hence, the diameters of the injection through-hole 21 and the air discharge through-hole 22 are not limited to those described in conjunction with the present embodiment. For example, the air discharge through-hole 22 may be larger in diameter than the injection through-hole 21. Besides, the air discharge through-hole 22 may be shaped like a rectangle or a polygon instead of being circular in shape.

### Second Embodiment

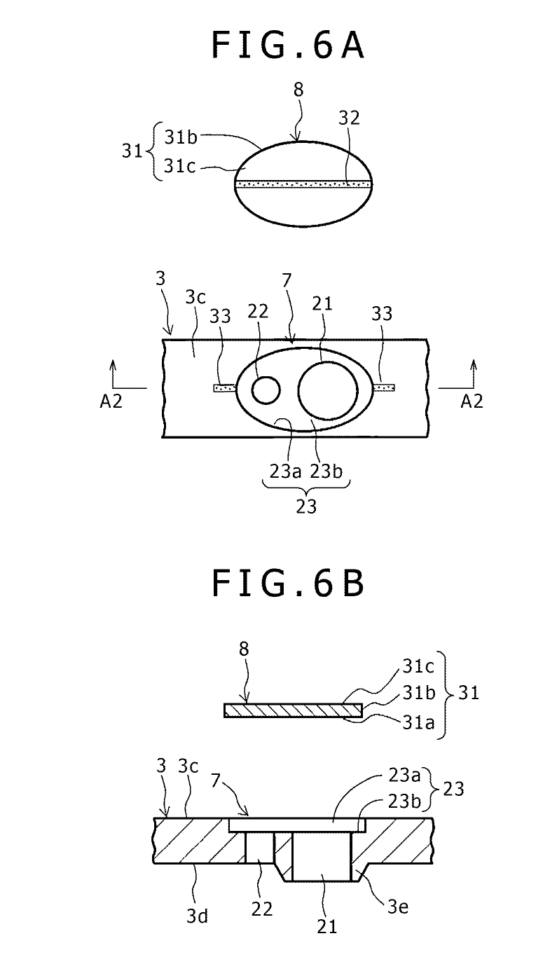

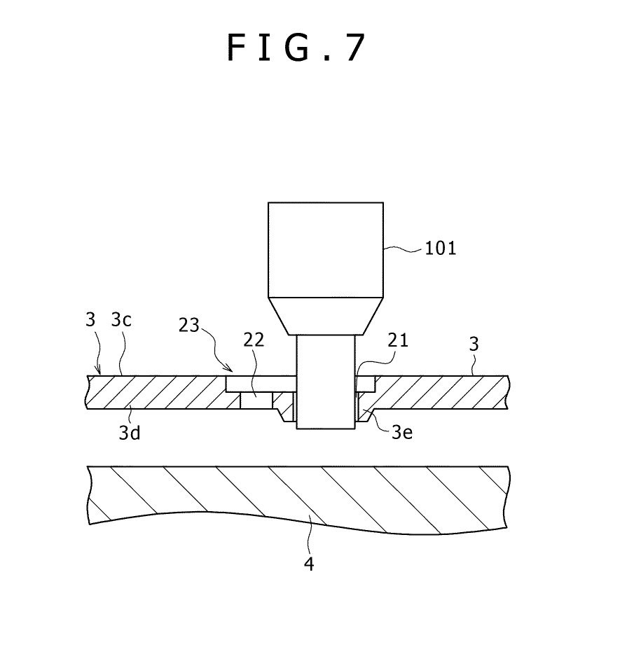

A second embodiment of the present invention will now be described with reference to FIGS. 6A, 6B, and 7. Elements identical with those of the first embodiment are designated by the same reference signs and will not be redundantly described in detail.

The second embodiment is characteristically configured so that the solution injection section 7 has a convex portion 3e, which is formed on the back surface of the cell lid 3, and that the lower end of the injection through-hole 21 is open to the leading end of the convex portion 3e, and further that the lower end of the air discharge through-hole 22 is open to the back surface of the cell lid 3.

As shown in FIGS. 6A and 6B, the solution injection section 7 has the injection through-hole 21 and the air discharge through-hole 22. The injection through-hole 21 and the air discharge through-hole 22 are disposed adjacent to each other. The upper ends of these through-holes 21, 22 are open to the bottom surface 23b of the concave portion 23.

Although the lower end of the air discharge through-hole 22 is open to the back surface of the cell lid 3, the lower end of the injection through-hole 21 is open to the leading end of the convex portion 3e formed on the back surface 3d of the cell lid 3. Hence, the lower end of the injection through-hole 21 is positioned below the lower end of the air discharge through-hole 22.

If, for instance, the discharge speed of the electrolytic solution, which is to be discharged from the solution injection nozzle 101 inserted into the injection through-hole 21, is increased in order to reduce the time required for the solution injection process, it is anticipated that the electrolytic solution may scatter in the cell can 2. In the present embodiment, the lower end of the injection through-hole 21 is positioned below the lower end of the air discharge through-hole 22 as shown in FIG. 7 to provide a height difference between the lower ends of the two through-holes. Therefore, the electrolytic solution discharged from the solution injection nozzle 101 can be effectively prevented from scattering toward the air discharge through-hole 22. This makes it possible to steadily discharge the air in the cell can 2 from the air discharge through-hole 22 and steadily inject the electrolytic solution.

### Third Embodiment

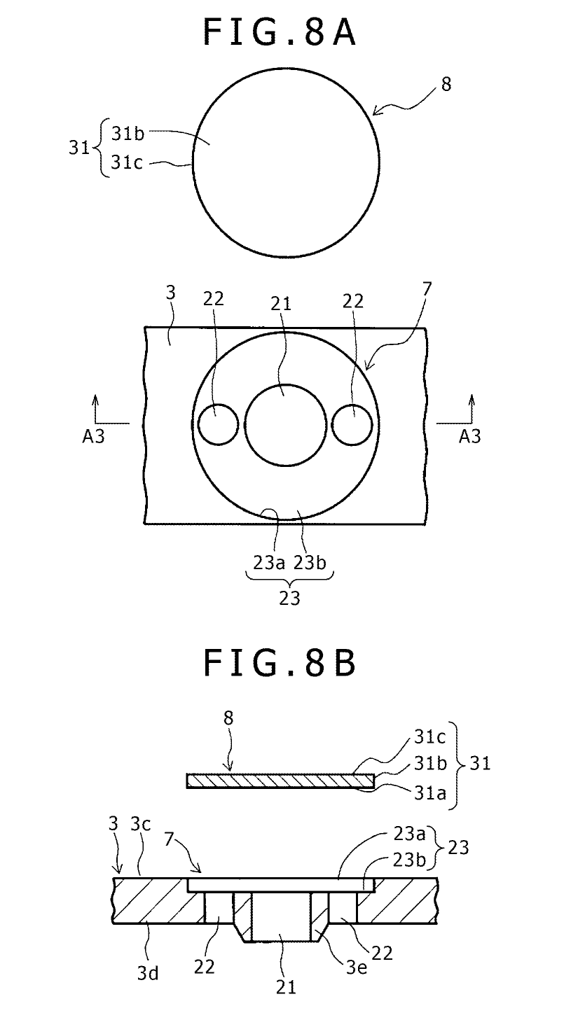

A third embodiment of the present invention will now be described with reference to FIGS. 8A and 8B. Elements identical with those of the foregoing embodiments are designated by the same reference signs and will not be redundantly described in detail.

The third embodiment is characteristically configured so that the shapes of the concave portion 23 and the plug 31, which are elliptical in the second embodiment, are changed to circular, and that the injection through-hole 21 is disposed at the center of the circle of the concave portion 23, and further that the air discharge through-hole 22 is disposed beside the injection through-hole 21.

In the present embodiment, two units of the air discharge through-hole 22 are disposed apart from each other in the direction of the long side of the cell lid 3 with the injection through-hole 21 positioned in between. It means that the number of units of the air discharge through-hole 22 is larger than in the second embodiment. In other words, the air can be discharged in a plurality of directions.

Consequently, the air in the cell can 2 can be steadily discharged. This makes it possible to steadily inject the electrolytic solution. Further, as the plug 31 is circular in shape, it can be more easily formed than the elliptically shaped plug. Furthermore, when the plug 31 is to be engaged with the concave portion 23, its orientation need not be adjusted for the concave portion 23. Hence, the plug 31 can easily be engaged with the concave portion 23. Although FIG. 8 indicates that the plug 31 is circular in shape, it may be elliptically shaped.

While the embodiments of the present invention have been described above, the present invention is not limited to the forgoing embodiments, but extends to various modifications based on design changes that fall within the spirit and scope of the appended claims. For example, the foregoing preferred embodiments are described in detail for better understanding of the present invention. The present invention is not limited to embodiments that include all the elements described above. Some elements of an embodiment may be replaced by some elements of another embodiment or some elements of an embodiment may be added to the elements of another embodiment. Further, some elements of an embodiment may be subjected to the addition of other elements, deleted, or replaced by other elements.

### LIST OF REFERENCE SIGNS

1 . . . Prismatic secondary cell
2 . . . Cell can
3 . . . Cell lid
3e . . . Convex portion
4 . . . Electrode group
7 . . . Solution injection section
8 . . . Plug section
21 . . . Injection through-hole (large-diameter through-hole)
22 . . . Air discharge through-hole (small-diameter through-hole)
23 . . . Concave portion
31 . . . Plug
32, 33 . . . Positioning marking

1. A prismatic secondary cell in which an electrode group is housed in a cell can and an opening in the cell can is sealed with a cell lid, the prismatic secondary cell comprising:
a solution injection section having a plurality of through-holes that penetrate the cell lid and are positioned adjacent to each other; and
a plug section that is attached to the solution injection section to seal the through-holes,
wherein the solution injection section includes a concave portion formed on the front surface of the cell lid, the upper ends of the through-holes being open to the bottom surface of the concave portion, and
wherein the plug section includes a plug that engages with the concave portion to come into planar contact with the bottom surface of the concave portion and integrally block up the through-holes.

2. (canceled)

3. The prismatic secondary cell according to claim 1,
wherein the through-holes include a large-diameter through-hole and a small-diameter through-hole, and
wherein the diameter of the large-diameter through-hole is larger than the diameter of the small-diameter through-hole.

4. The prismatic secondary cell according to claim 3,
wherein the solution injection section is configured so that the concave portion is elliptically shaped as viewed from above, and
wherein the through-holes are disposed adjacent to each other in the longitudinal axis direction of the ellipse of the concave portion.

5. The prismatic secondary cell according to claim 3,
wherein the solution injection section is configured so that the concave portion is circularly shaped as viewed from above,
wherein the large-diameter through-hole is disposed at the center of the circle of the concave portion, and
wherein the small-diameter through-hole is disposed in the concave portion and positioned beside the large-diameter through-hole, which is disposed at the center of the circle of the concave portion.

6. The prismatic secondary cell according to claim 3,
wherein the solution injection section includes a convex portion that is formed on the back surface of the cell lid,
wherein the lower end of the large-diameter through-hole is open to the leading end of the convex portion, and
wherein the lower end of the small-diameter through-hole is open to the back surface of the cell lid.

7. The prismatic secondary cell according to claim 3,
wherein the large-diameter through-hole is an injection through-hole, and
wherein the small-diameter through-hole is an air discharge through-hole.

8. The prismatic secondary cell according to claim 7,
wherein the electrode group is flat in shape and has a pair of wide surfaces and a pair of narrow surfaces,
wherein the cell can is shaped like a rectangular box having an oblong bottom wall surface, a pair of wide side wall surfaces that are bent at a long side of the bottom wall surface to face each other and oppose each of the wide surfaces of the electrode group, and a pair of narrow side wall surfaces that are bent at an end side of the bottom wall surface to face each other and oppose each of the narrow surfaces of the electrode group,
wherein the cell lid is shaped like a rectangular flat plate that blocks up an opening in the cell can between the upper ends of the pair of wide side wall surfaces and between the upper ends of the pair of narrow side wall surfaces, and
wherein the solution injection section is configured so that the injection through-hole is disposed closer to the narrow side wall surfaces of the cell can than the air discharge through-hole.

9. The prismatic secondary cell according to claim 1, wherein the through-holes are positioned so that the bottom surface exists along the whole circumference of the upper end of each of the through-holes.

10. The prismatic secondary cell according to claim 1, wherein the cell lid and the plug section are marked with a positioning marking that is used to properly position the cell lid and the plug section.
